(19) United States
(12) Patent Application Publication
(10) Pub. No.: US 2015/0082936 A1
(43) Pub. Date: Mar. 26, 2015

(54) Steering Column Damper Element and Steering Column Arrangement

(71) Applicant: Daimler AG, Stuttgart (DE)

(72) Inventors: Axel Hebenstreit, Stuttgart (DE); Steffen Kraus, Kornwestheim (DE); Steffen Schulze, Stuttgart (DE)

(73) Assignee: Daimler AG, Stuttgart (DE)

(21) Appl. No.: 14/387,124

(22) PCT Filed: Jan. 19, 2013
(86) PCT No.: PCT/EP2013/000159

§ 371 Date: Sep. 22, 2014

(30) Foreign Application Priority Data
Mar. 23, 2012 (DE) 10 2012 005 834.9

(51) Int. Cl. B62D 7/22; F16F 15/126; F16F 1/377; F16F 1/373

(52) U.S. Cl. CPC B62D 7/224; F16F 1/3732; F16F 15/126; F16F 1/377
USPC 74/492; 267/141.2

(57) ABSTRACT

A steering column damper element is arranged between an outer shaft and an inner shaft and is accommodated inside the outer shaft at least in sections and coaxially. The steering column damper element is formed as an elastomer ring that has a hardness of 40 to 80 Shore and has at least one hole running axially.

### BACKGROUND AND SUMMARY OF THE INVENTION

Exemplary embodiments of the invention relate to a steering column damper element for arrangement between an outer shaft and an inner shaft that is accommodated inside the outer shaft at least in sections and coaxially, and a corresponding steering column arrangement.

It is known from the prior art to decouple the vibrations and sounds induced by the chassis in the direction of the steering wheel using a decoupling element arranged in the steering column. Conventional decoupling elements are a compromise between static stiffness, translational as well as rotatory, and the dynamic decoupling behavior. Generally a good decoupling behavior with a low level of stiffness and vice versa is therefore usual.

Conventional rubber elastic damper elements for the decoupling of vibrations and peak torques generally have a linear stiffness and a narrowly limited maximum transferable torque. In order to achieve improved decoupling, fiber-reinforced elastomer components are partly introduced with freely adjustable stiffness characteristic curves. This is achieved by a defined and targeted insertion of thread packages into an elastomer. However, such flexible discs need a large installation space; additionally, the component cannot be penetrated in the case of a crash. Furthermore, the rotatory stiffness starkly deteriorates over its lifespan.

In a conventional damping cartridge, according to the tube-in-tube principle, the cited dependence between the dynamic decoupling behavior and static stiffness exists.

German patent document DE 10 2008 038 029 A1 describes such a coupling device for a vehicle steering wheel, having an elastic layer as a decoupling element between an outer shaft and an inner shaft. Here, German patent document DE 10 2008 038 029 A1 focuses on the constructional design, wherein the covering outer surface of the inner shaft has at least one outer flat region and the covering inner surface of the outer shaft has a corresponding inner flat region.

In view of this prior art exemplary embodiments of the present invention are directed to an improved decoupling element having good decoupling properties in combination with high stiffness.

A first embodiment of a steering column damper element according to the invention, which serves for the vibration decoupling of the steering wheel from the chassis with high translational and rotatory stiffness, is formed from an elastomer. The steering column damper element is between an outer shaft and an inner shaft that is accommodated by the outer shaft at least in sections and coaxially. The elastomer steering column damper element according to the invention is formed as an elastomer ring, having a hardness of 40 to 80 Shore. In order to adjust the decoupling behavior and stiffness, the elastomer ring has at least one hole running axially. In this way, good dynamic decoupling properties between the chassis and steering wheel with both high translational and rotatory stiffness are possible.

Further parameters for the adjustment of decoupling behavior and stiffness include the thickness and length of the elastomer ring as well as the number, type and distribution of the holes. The types of holes comprise clearance holes and blind holes, and the distribution of holes refers to the arrangement of the blind holes on one or both sides. If the holes provided are blind holes, which are additionally arranged on both sides, the axial overlap of the blind holes arranged on both sides or the length of the overlap thus furthermore plays a role with respect to decoupling behavior and stiffness. The parameters can be adjusted in such a way that a predetermined or desired stiffness and desired decoupling behavior of the steering column damper element is obtained in an axial, radial and peripheral direction. Thus, increasing thickness and increasing length as well as the reduction in the number of holes or the reduction in the clearance holes, and a reduction (of length) in the overlap has an effect of increasing stiffness.

If an elastomer ring is provided with blind holes arranged on both sides, these can be arranged offset to one another along the elastomer ring. The number of blind holes on both sides can thus be the same or different.

Suitable elastomers for the formation of the elastomer ring according to the invention are nitrile rubber, carboxylated nitrile rubber or ethylene-acrylate rubber.

The elastomer ring forming the steering column damper element can furthermore be held in a press fit between an inner and an outer carrier ring.

The invention furthermore relates to a steering column arrangement having an inner shaft and an outer shaft, in which the inner shaft is included at least in sections and coaxially. The steering column arrangement comprises a steering column damper element arranged between the inner shaft and the outer shaft, which is a steering column damper element designed according to the invention made from an elastomer ring.

The inner shaft can be a sliding sleeve for receiving a steering spindle, while the outer shaft is formed by the receiving section of a universal joint yoke. The steering column damper element can be arranged in a press fit between the sliding sleeve and the receiving section.

The steering column damper element formed as an elastomer ring according to the invention has a smaller installation space requirement with respect to the diameter compared to a fiber-reinforced flexible disc with corresponding properties from the prior art; furthermore, in the case of a crash, the steering spindle can penetrate the steering column damper element according to the invention. The values of the stiffness and decoupling behavior also stay stable throughout the entire lifespan of the steering column damper element.

These and other advantages are demonstrated by the description below with reference to the accompanying figures. The reference to the figures in the description serves for the simplified understanding of the subject matter. The figures are only a schematic depiction of an embodiment of the invention.

### BRIEF DESCRIPTION OF THE DRAWING FIGURES

Here are shown:

FIG. 1 a cross-sectional view of the elastomer ring,

FIG. 2 a longitudinal view of the elastomer ring along line A-A from FIG. 1,

### DETAILED DESCRIPTION

The elastomer ring according to the invention forms a vibration damper for a steering column; it is arranged in a receptor of a universal joint yoke. The receiving section of the universal joint yoke frequently has a cylindrical outer cover.

In order to achieve an as good a decoupling as possible of the vibrations arising in the chassis from the steering train and at the same time to guarantee a high level of stiffness of the steering column for good steering comfort, the elastomer ring is made out of an elastomer with a Shore hardness of 40 to 80 and has at least one hole running axially.

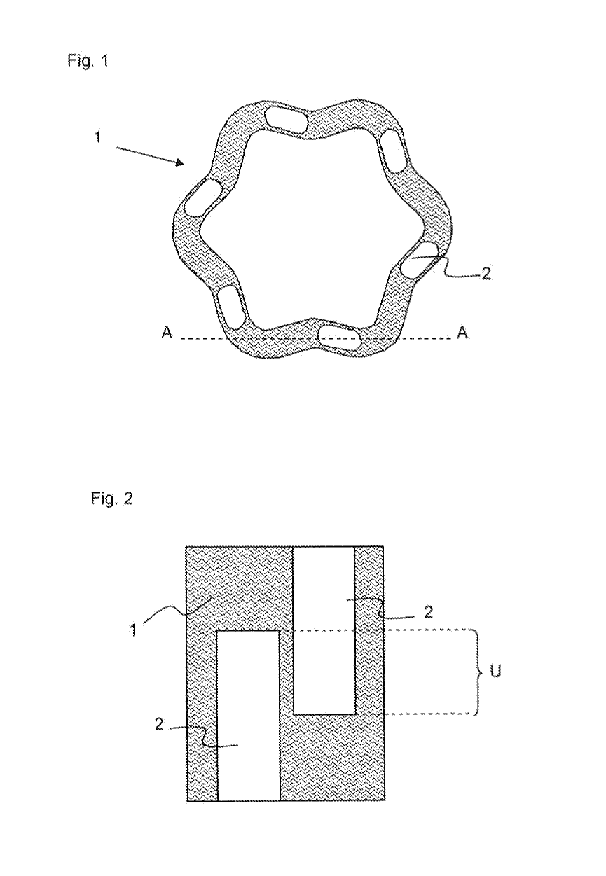

FIG. 1 shows a cross-sectional view of a star-shaped elastomer ring 1, in which six axial holes 2 are to be seen with even distribution. The axial holes 2 are blind holes 2, as can be seen in the longitudinal sectional view of FIG. 2, which runs along the line A-A in FIG. 1. Here, it is also shown what was not visible in the cross-sectional view in FIG. 1: The elastomer ring 1 is fitted with blind holes 2 arranged on both sides, which overlap in an axial direction in a region U. The ring 1 in FIG. 1 can, for example in the transfer of the longitudinal sectional view to all six “upwardly” arranged blind holes 2, also have six on the blind holes arranged on the underside.

In order to achieve an optimal relation between stiffness and decoupling behavior (axial, radial and in the perpendicular direction), the following parameters can be coordinated with one another:
the thickness or wall strength of the elastomer ring 1, wherein the stiffness increases with increasing wall strength,
the length of the elastomer ring 1, wherein, here, the stiffness also increases with increasing length,
the number of holes 2, wherein the stiffness increases the fewer holes 2 there are,
the type of holes 2, so whether these are clearance holes or blind holes 2, wherein blind holes 2 are preferred, since the stiffness increases the fewer clearance holes there are,
the arrangement and distribution of the holes 2. The blind holes 2 as shown in FIG. 2, can be provided on both sides in the elastomer ring 1, so virtually from behind and from in front, also according to the different or same number, whereby a homogenization of the stiffness or decoupling can be achieved.

Furthermore, an axial overlap U can be present and adjusted between the blind holes 2 arranged on both sides, or its length can be adjusted. Here, the stiffness increases when the overlap U decreases. With blind holes 2 arranged on both sides, having an axial overlap U, a particularly good result can in principle be achieved during the adjustment of the parameters.

Thus the internal structure of the damper element allows high stiffness with good decoupling behavior.

The material used to manufacture the elastomer ring 1 can preferably consist of NBR (nitrile rubber), XBR (carboxylated nitrile rubber) or AEM (ethylene acrylate rubber).

The elastomer ring can be held in a press fit between an inner and an outer carrier ring. To create the holes, the arrangement of the inner and outer carrier ring can only be partially filled with the elastomer. Through partial binding of the inner and outer carrier ring, the desired properties can be achieved.

The steering column damper element formed by the elastomer ring can be between an outer shaft and an inner shaft that is accommodated inside the outer shaft at least in sections and coaxially and thus can form a steering column arrangement having both translational as well as rotatory static stiffness. Thus, at the same time, good dynamic decoupling properties between the chassis and steering wheel are achieved. Here, the elastomer ring can be pressed onto a sliding sleeve forming the inner shaft, which in turn is received in a receiving section of a universal joint yoke, which forms the outer shaft.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-7. (canceled)

8. A steering column damper element, comprising:
an elastomer having a hardness of 40 to 80 Shore; and
at least one hole running axially in the steering column damper element,
wherein the steering column damper element has a ring shape and is configured for arrangement between an outer shaft and an inner shaft that is accommodated inside the outer shaft at least in sections and coaxially.

9. The steering column damper element of claim 8, wherein depending on a predetermined stiffness and a predetermined decoupling behavior of the steering column damper element in an axial direction, radial direction, and peripheral direction the elastomer ring, the steering column damper element has
a selected thickness,
a selected length of holes,
a selected number of holes,
a selected distribution of holes, or
a selected axial overlap between holes and a selected length of overlap between holes, wherein the holes are blind holes arranged both sides of the steering column damper element.

10. The steering column damper element of claim 9, wherein the blind holes arranged on both sides are arranged offset to one another along the elastomer ring, wherein the number of blind holes on each side is the same.

11. The steering column damper element of claim 9, wherein the blind holes arranged on both sides are arranged offset to one another along the elastomer ring, wherein the number of blind holes on each side is different.

12. The steering column damper element of claim 8, wherein the elastomer consists of nitrile rubber, carboxylated nitrile rubber, or ethylene acrylate rubber.

13. The steering column damper element of claim 8, wherein the elastomer ring is held by a press fit between an inner and an outer carrier ring.

14. A steering column arrangement, comprising:
an inner shaft;
an outer shaft, in which the inner shaft is included at least in sections and coaxially; and
a steering column damper element arranged between the inner shaft and the outer shaft, wherein the steering column damper element is an elastomer having a hardness of 40 to 80 Shore, includes at least one hole running axially, and has a ring shape.

15. The steering column arrangement of claim 14, wherein the inner shaft is a sliding sleeve configured to receive a steering column and the outer shaft is a receiving section of a universal joint yoke, wherein the steering column damper element is arranged in a press fit between the sliding sleeve and the receiving section.
